(19) United States
(12) Patent Application Publication
(10) Pub. No.: US 2012/0052723 A1
(43) Pub. Date: Mar. 1, 2012

(54) WALL PLATE ASSEMBLY

(75) Inventors: CHEN-XI WANG, Kunshan (CN); HONG-QIANG HAN, Kunshan (CN); ZI-QIANG ZHU, Kunshan (CN)

(73) Assignee: HON HAI PRECISION INDUSTRY CO., LTD., New Taipei (TW)

(21) Appl. No.: 13/221,816

(22) Filed: Aug. 30, 2011

(30) Foreign Application Priority Data
Sep. 1, 2010 (CN) 201020513064.9

(51) Int. Cl. H01R 13/73; H01R 31/06

(52) U.S. Cl. 439/536; 439/628

(57) ABSTRACT

A wall plate assembly (100) includes a wall plate (20) having an opening (201) passing therethrough, and an adapter (10) fixedly provided at a back side of said wall plate. The adapter (10) includes a printed circuit board (101), and a first and second connectors (102, 103) mounted onto the printed circuit board in a back to back manner. The first connector includes an insulative housing (1), a metal shell (3) having a receiving space (106), and a set of contacts (2) disposed on the insulative housing. The contacts (2) have contacting portions (21) extending into the receiving space and tail portions (23) being mounted onto the printed circuit board. The second connector (103) includes a dielectric body (4) and a set of terminals (5) disposed on the dielectric body. The terminals have mating sections (51) and tail sections (53) being mounted onto the printed circuit board. The printed circuit board (101) is located between the insulative housing (1) and the dielectric body (4) in the front-to-back direction.

### BACKGROUND OF THE INVENTION

1. Field of the Invention

The present invention relates to a wall plate assembly, and more particularly to a wall plate assembly having an adapter attached to a wall plate.

2. Description of Related Art

At present, many types of high speed transmission connectors such as HDMI (High Definition Multimedia Interface), DisplayPort, or DiiVA (Digital Interactive Interface for Video & Audio) connectors are widely used as input/output interfaces adapted for many electronic devices, such as personal computer and related peripherals so as to transmit high quality audio and video signals. Disposition of these electronic devices in house requires extra spaces and extending the length of cables to provide a remote connection of these electronic devices. However, it is neither beautiful nor safe to directly arrange the cables on outsides of the walls, the floor or the ceiling of the house.

Hence, a wall plate assembly is desired to overcome the above problems.

### BRIEF SUMMARY OF THE INVENTION

According to one aspect of the present invention, a wall plate assembly comprises: a wall plate defining an opening passing therethrough in a front-to-back direction, and an adapter fixedly provided at a back side of said wall plate. The adapter comprises a printed circuit board, and a first and second connectors mounted onto the printed circuit board in a back to back manner. The first connector comprises an insulative housing, a metal shell retained on the insulative housing and defining a receiving space corresponding to the opening for receiving a first plug, and a plurality of contacts disposed on the insulative housing. The contacts have contacting portions extending into the receiving space for mating with the first plug and tail portions being mounted onto the printed circuit board. The second connector comprises a dielectric body and a plurality of terminals disposed on the dielectric body. The terminals have mating sections for mating with a second plug and tail sections being mounted onto the printed circuit board. Wherein the printed circuit board is located between the insulative housing and the dielectric body in the front-to-back direction.

According to another aspect of the present invention, a wall plate assembly for being installed on a wall of a house comprises: a wall plate defining an opening passing therethrough in a front-to-back direction, and an adapter fixedly provided at a back side of said wall plate. The adapter comprises a printed circuit board, a first connector corresponding to the opening and being mounted onto the printed circuit board, a second connector being mounted onto the printed circuit board with its back towards the first connector and hidden into the wall of the house, and a case surrounding the printed circuit board, the first and second connectors. The first connector comprises an insulative housing, a metal shell retained on the insulative housing and defining a receiving space corresponding to the opening for receiving a first plug, and a plurality of contacts disposed on the insulative housing. The contacts have contacting portions extending into the receiving space for mating with the first plug and tail portions being mounted onto the printed circuit board. The second connector comprises a dielectric body and a plurality of terminals disposed on the dielectric body. The dielectric body has a chamber recessed backwardly from a front face thereof for insertion of a second plug and a ladder integrally protruding into the chamber therefrom. The terminals have mating sections extending out of the ladder and into the chamber for mating with the second plug, and tail sections being mounted onto the printed circuit board.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a wall plate assembly according to an embodiment of the present invention;

FIG. 2 is a partially exploded view of the wall plate assembly with a wall plate removed therefrom;

FIG. 3 is similar to FIG. 2, but viewed from another aspect;

FIG. 4 is an exploded view of the wall plate assembly shown in FIG. 2; and

FIG. 5 is similar to FIG. 4, but viewed from another aspect.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details.

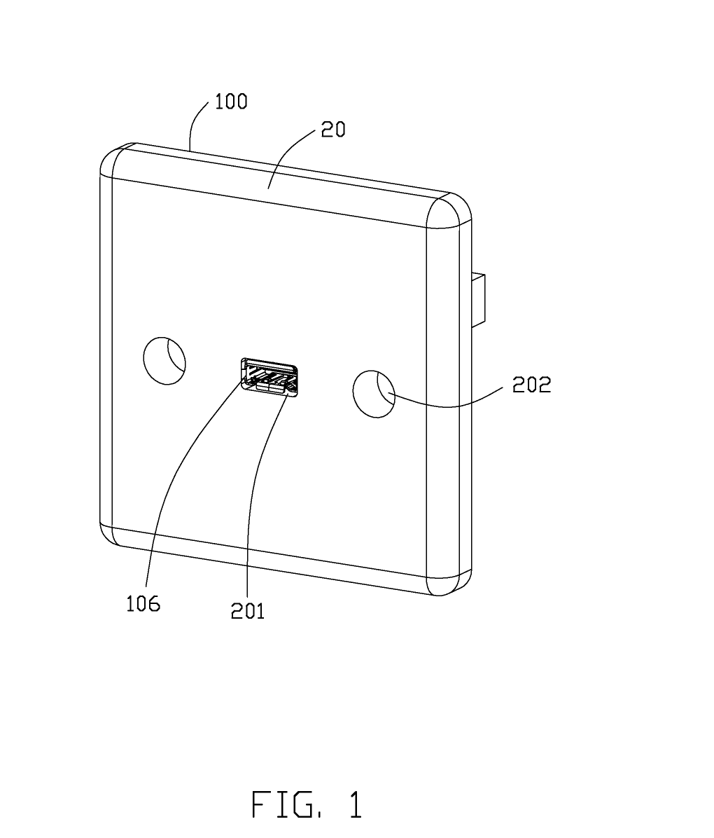

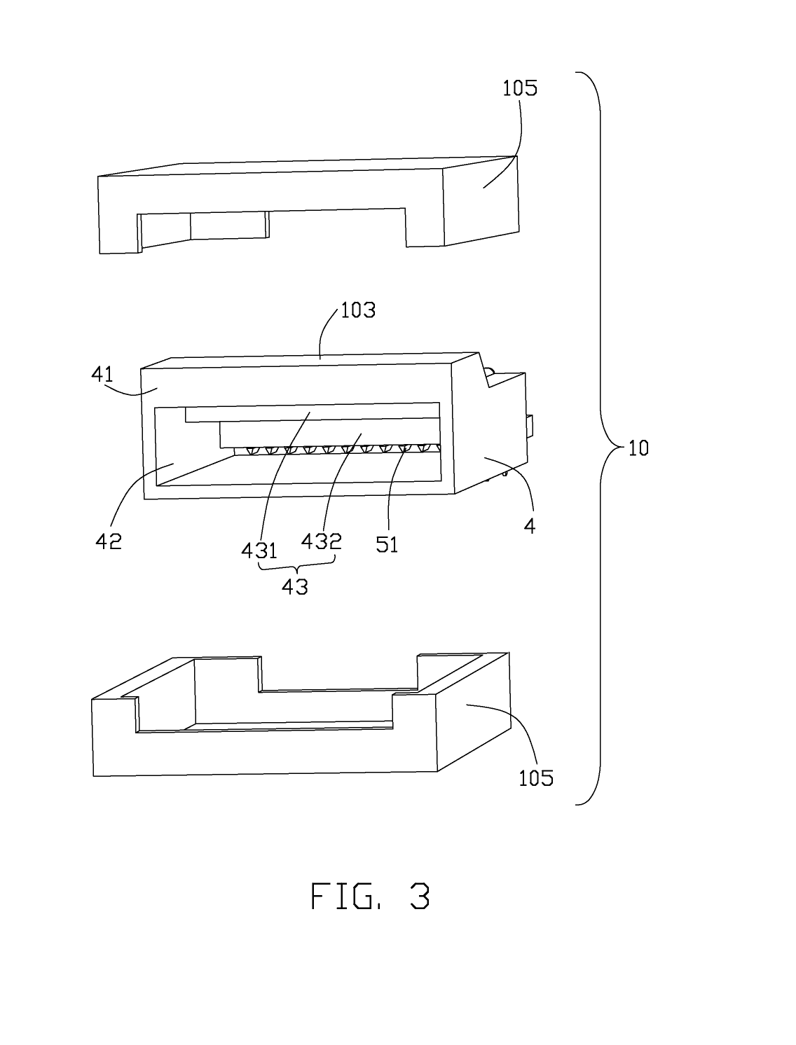

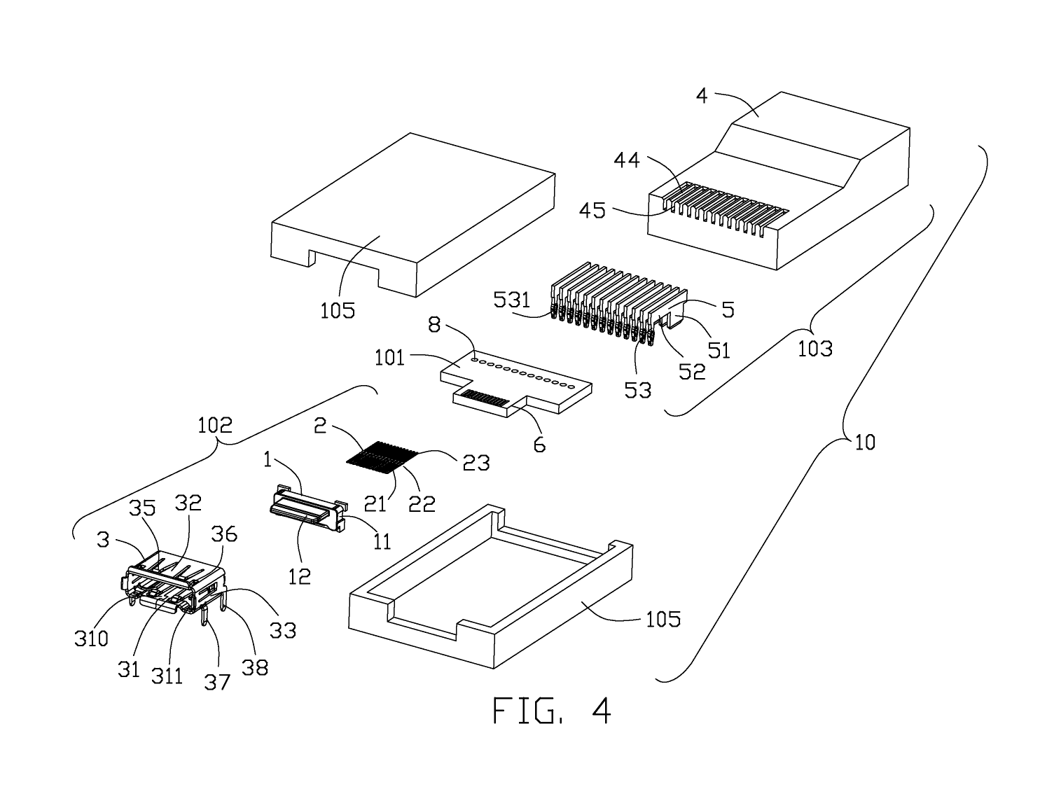

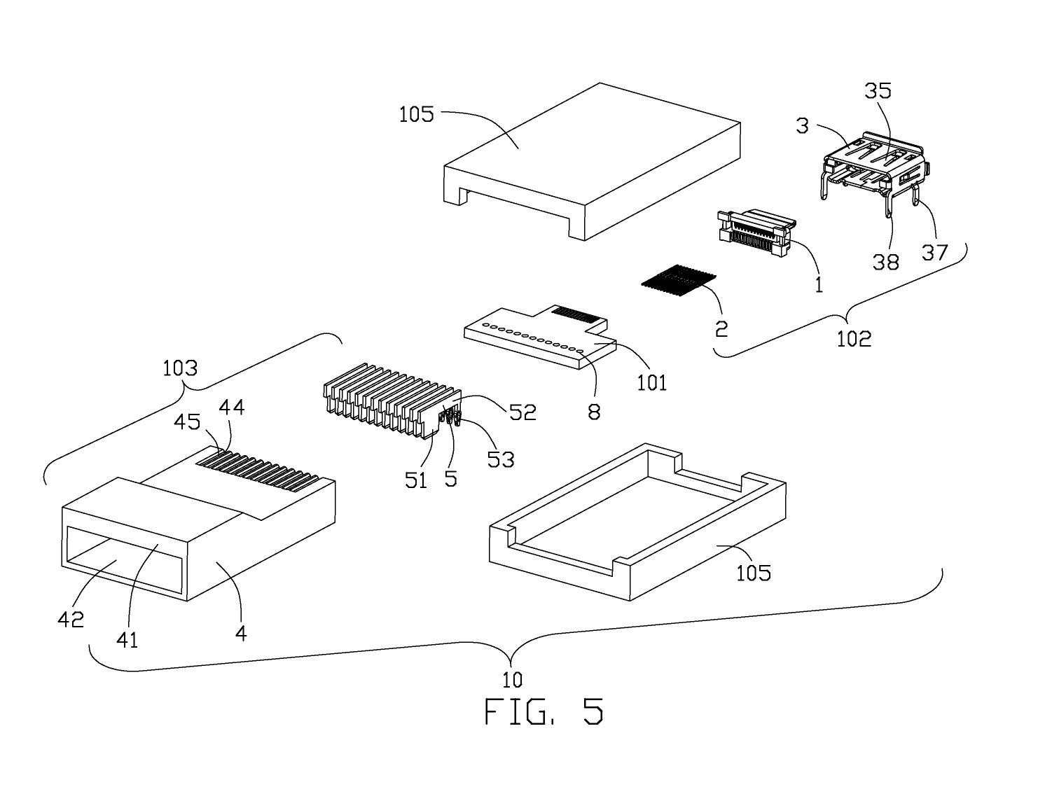

Referring to FIGS. 1-5, a wall plate assembly 100 according to an embodiment of the present invention is provided for being installed on a wall, a ceiling or a floor of a house. The wall plate assembly 100 comprises a wall plate 20 having an opening 201 passing therethrough in a front-to-back direction, an adapter 10 assembled to the wall plate 20 and corresponding to the opening 201. The wall plate 20 has a pair of screw holes 202 formed thereon for a pair of screws (not shown) assembled thereto so as to orientate the wall plate 20 onto the wall, ceiling or floor of the house.

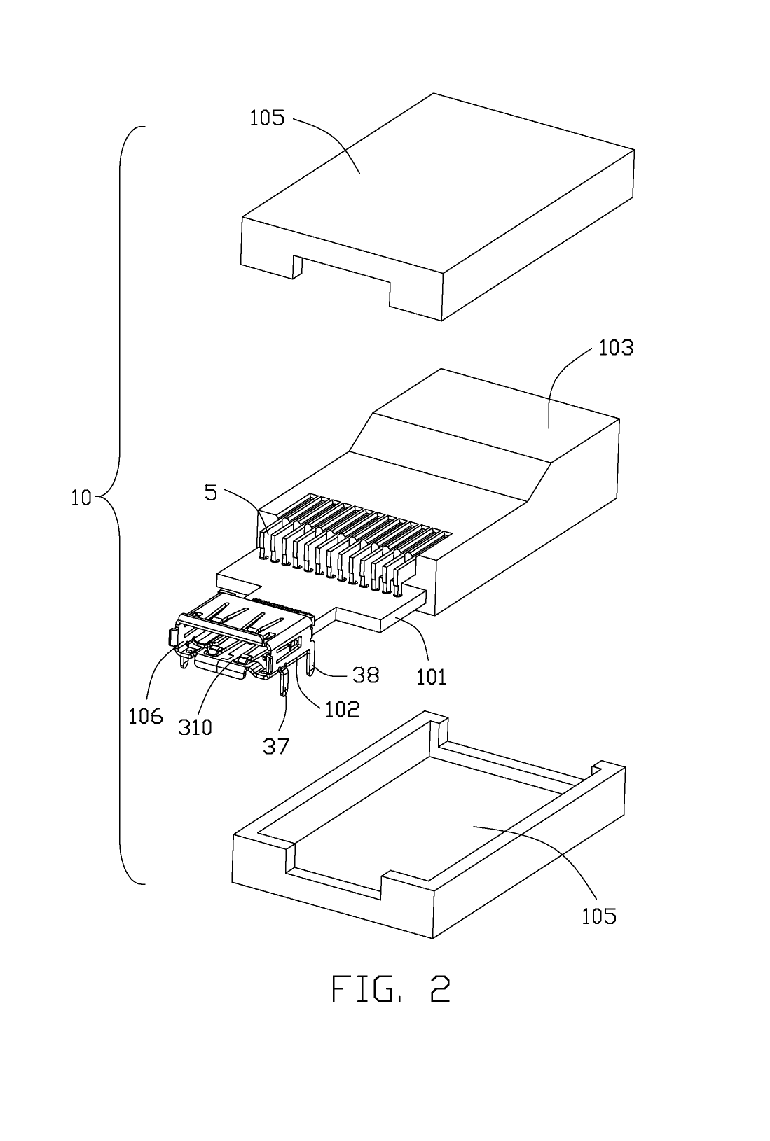

Referring to FIGS. 2-5, the adapter 10 includes a PCB (printed circuit board) 101, a first and second connectors 102, 103 mounted onto the PCB 101 simultaneously in a back to back manner, and a case 105 surrounding the PCB 101, and the first and second connectors 102, 103. In this embodiment, the first connector 102 is different from the second connector 103, the first connector is a DiiVA (Digital Interactive Interface for Video & Audio) receptacle connectors. It is also to be understood, in other embodiments, the first connector 102 could be a HDMI (High Definition Multimedia Interface) receptacle connectors, a DisplayPort receptacle connector, or other connectors.

The first connector 102 is mounted onto a contractible portion 6 of the PCB 101 and includes an insulative housing 1 located at front of the contractible portion 6, a plurality of contacts 2 disposed on the insulative housing 1 and a metal shell 3 assembled to the insulative housing 1.

The insulative housing 1 has a main portion 11 and a tongue portion 12 extending forwardly from a front end of the main portion 11. The contacts 2 have contacting portions 21 arranged in one row and retained in a lower surface of the tongue portion 12, tail portions 23 extending backwardly beyond the insulative housing 1 and arranged in one row, and connecting portions 22 retained in the insulative housing 1 and connecting the contacting portions 21 and the tail portions 23. The tail portions 23 are mounted on a surface of the contracting portion 6. Each contact 2 extends in a linear manner along the front-to-back direction. In this embodiment, the contacts 2 are assembled to the insulative housing 1, it is also to be understood, in other embodiments, the contacts 2 could be insert molded into the insulative housing 1. The metal shell 3 is stamped and formed from conductive sheet metal material. The metal shell 3 is retained around the main portion 11. The metal shell 3 has a planar top wall 32, a bottom wall 31 opposite to the top wall 32, a pair of side walls 33 connecting the top wall 32 and the bottom wall 31, and a receiving space 106 surrounded by the top wall 32, the bottom wall 31 and the side walls 33 and corresponding to the opening 201 for receiving a first plug (not shown). The tongue portion 12 and the contacting portions 21 are accommodated in the receiving space 106. The bottom wall 31 has a depressed wall 310 depressed upwardly toward the receiving space 106 so as to prevent the first plug from mismating the first connector 102, and a pair of connecting walls 311 connecting the side walls 33 and the depressed wall 310. The connecting walls 311 have a same width in the transverse direction and are parallel to the top wall 32. Each of the top wall 32 and the depressed wall 310 has a pair of spring tabs 35 extending forwardly and protruding inwardly into the receiving space 106. The top wall 32 has a pair of perforations 36 at two lateral sides of the spring tabs 35 for being latched by the first plug. The metal shell 3 has a pair of first legs 37 torn downwardly from the bottom wall 31 and connecting to the two side walls 33, and a pair of second legs 38 extending downwardly from the two side walls 33 and located behind the first legs 37.

The second connector 103 is mounted onto a rear portion of the PCB 101 and comprises a dielectric body 4 and a plurality of terminals 5 assembled to the dielectric body 4. The dielectric body 4 has a chamber 42 recessed backwardly from a front face 41 thereof for insertion of a second plug (not shown) which connects to a cable extending into the wall, the ceiling or the floor of the house, and a ladder 43 protruding downwardly into the chamber 42 so as to prevent the second plug from mismating the second connector 103. The ladder 43 includes a first step 431 protruding downwardly from a top plate which surrounds a top side of the chamber 42 and a second step 432 protruding downwardly from the first step 431. The dielectric body 4 has a plurality of protrusions 44 formed at a rear side thereof, and forms a plurality of grooves 45 between each two adjacent protrusions 44 and communicating with exterior in both an upper and a rear sides. The terminals 5 are assembled to the dielectric body 4 from an upper-to-lower direction and comprise connecting sections 52 received in the grooves 45, mating sections 51 extending downwardly from lower sides of the connecting sections 52, and tail sections 53 extending downwardly from the lower sides of the connecting sections 52 and spaced apart from the mating sections 51 in the front-to-back direction. The mating sections 51 extend downwardly beyond the second step 432 and into the chamber 42 so as to mate with the second plug. The tail sections 53 each has an aperture 531 passing therethrough in the transverse direction so that the tail sections 53 could be mounted into holes 8 of the PCB 101 in a press-fit technology. The connecting sections 52 of the terminals 5 have upper sides and rear sides exposed to exterior, therefore, the terminals 5 could dissipate heat fast and effectively.

The PCB 101 is located between the insulative housing 1 and the dielectric body 4 in the front-to-back direction. The PCB 101 has a height smaller than both a first height of the insulative housing 1 and a second height of the dielectric body 4 in the upper-to-lower direction. The PCB 101 does not exceed lower surfaces and upper surfaces of both the insulative housing 1 and the dielectric body 4 in the upper-to-lower direction. Therefore, no more space is needed in the upper-to-lower direction for disposing the PCB 101, and the height of the adapter 10 could be reduced.

When the wall plate assembly 100 is installed onto the wall, the ceiling or the floor of the house, the first connector 102 received in the opening 201 can mate with the first plug to connect to an electrical device, the second connector 103 is hidden into the wall, the ceiling or the floor of the house and mate with the second plug. The first and second connectors 102, 103 are converted into each other via the PCB 101, the first connector 102 does not directly connect to the cable which extends into the wall, the ceiling or the floor of the house and will be replaced expediently with another one when it does not work.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A wall plate assembly comprising:
a wall plate defining an opening passing therethrough in a front-to-back direction; and
an adapter fixedly provided at a back side of said wall plate and comprising a printed circuit board, and a first and second connectors mounted onto the printed circuit board in a back to back manner, the first connector comprising an insulative housing, a metal shell retained on the insulative housing and defining a receiving space corresponding to the opening for receiving a first plug, and a plurality of contacts disposed on the insulative housing, the contacts having contacting portions extending into the receiving space for mating with the first plug and tail portions being mounted onto the printed circuit board, the second connector comprising a dielectric body and a plurality of terminals disposed on the dielectric body, the terminals having mating sections for mating with a second plug and tail sections being mounted onto the printed circuit board;
wherein the printed circuit board is located between the insulative housing and the dielectric body in the front-to-back direction.

2. The wall plate assembly according to claim 1, wherein the contacting portions and the tail portions are arranged in one row along a transverse direction perpendicular to the front-to-back direction, the tail portions are mounted on a surface of the printed circuit board, each contact extends in a linear manner along the front-to-back direction.

3. The wall plate assembly according to claim 1, wherein the printed circuit board is lower than both the insulative housing and the dielectric body in an upper-to-lower direction, and is located between upper surfaces and lower surfaces of both the insulative housing and dielectric body in the upper-to-lower direction.

4. The wall plate assembly according to claim 1, wherein the dielectric body has a chamber recessed backwardly from a front face thereof for insertion of the second plug and a ladder protruding into the chamber.

5. The wall plate assembly according to claim 4, wherein the ladder comprises a first step protruding downwardly from a top plate which surrounds a top side of the chamber and a second step protruding downwardly from the first step, the mating sections extend downwardly out of the second step and into the chamber to mate with the second plug.

6. The wall plate assembly according to claim 1, wherein the dielectric body has a plurality of protrusions formed at a rear side thereof, and forms a plurality grooves between each two adjacent protrusions and communicating with exterior in both an upper side and a rear side, the terminals have connecting sections received in the corresponding grooves, the mating section and the tail section of each terminal extend downwardly from a lower side of the corresponding connecting section simultaneously and are spaced apart from each other in the front-to-back direction.

7. The wall plate assembly according to claim 1, wherein each tail section has an aperture passing therethrough in a transverse direction perpendicular to the front-to-back direction and is mounted into a hole of the printed circuit board in a press-fit technology.

8. A wall plate assembly for being installed on a wall of a house comprising:
a wall plate defining an opening passing therethrough in a front-to-back direction; and
an adapter fixedly provided at a back side of said wall plate and comprising a printed circuit board, a first connector corresponding to the opening and being mounted onto the printed circuit board, a second connector being mounted onto the printed circuit board with its back towards the first connector and hidden into the wall of the house, and a case surrounding the printed circuit board, the first and second connectors, the first connector comprising an insulative housing, a metal shell retained on the insulative housing and defining a receiving space corresponding to the opening for receiving a first plug, and a plurality of contacts disposed on the insulative housing, the contacts having contacting portions extending into the receiving space for mating with the first plug and tail portions being mounted onto the printed circuit board, the second connector comprising a dielectric body and a plurality of terminals disposed on the dielectric body, the dielectric body having a chamber recessed backwardly from a front face thereof for insertion of a second plug and a ladder integrally protruding into the chamber therefrom, the terminals having mating sections extending out of the ladder and into the chamber for mating with the second plug, and tail sections being mounted onto the printed circuit board.

9. The wall plate assembly according to claim 8, wherein the printed circuit board is located between the insulative housing and the dielectric body in the front-to-back direction.

10. The wall plate assembly according to claim 9, wherein the printed circuit board has a height smaller than both a first height of the insulative housing and a second height of the dielectric body in an upper-to-lower direction, and does not exceed upper surfaces and lower surfaces of both the insulative housing and the dielectric body in the upper-to-lower direction.

11. The wall plate assembly according to claim 8, wherein the contacting portions and the tail portions are arranged in one row along a transverse direction perpendicular to the front-to-back direction, the tail portions are mounted on a surface of the printed circuit board, each contact extends in a linear manner along the front-to-back direction.

12. The wall plate assembly according to claim 8, wherein the ladder comprises a first step protruding downwardly from a top plate which surrounds a top side of the chamber and a second step protruding downwardly from the first step, the mating sections extend downwardly out of the second step and into the chamber to mate with the second plug.

13. The wall plate assembly according to claim 8, wherein the dielectric body has a plurality of protrusions formed at a rear side thereof, and forms a plurality grooves between each two adjacent protrusions and passing through an upper side and a rear side of the dielectric body, the terminals have connecting sections received in the corresponding grooves, the mating section and the tail section of each terminal extend downwardly from a lower side of the corresponding connecting section simultaneously and are spaced apart from each other in the front-to-back direction.

14. The wall plate assembly according to claim 8, wherein each tail section has an aperture passing therethrough in a transverse direction perpendicular to the front-to-back direction and is mounted into a hole of the printed circuit board in a press-fit technology.

15. An electrical connector assembly comprising:
a case including an upper half and a lower half commonly defining therein a receiving cavity communicating with an exterior via two opposite first and second end openings;
a dielectric body including an outer thick section exposed to the exterior via the second end opening, and an inner thin section received in the receiving cavity behind the second end opening;
a plurality of terminals disposed in the dielectric body;
a printed circuit board essentially fully received in the receiving cavity and defining a rear region located in the receiving cavity and connected to the terminals;
an electrical connector mounted upon a front region of the printed circuit boar for electrical connection with the terminals, and essentially fully receiving in the receiving cavity, and communicating with the exterior via the first end opening.

16. The electrical connector assembly as claimed in claim 15, wherein the first end opening is smaller than the second end opening.

17. The electrical connector assembly as claimed in claim 15, wherein each of the terminals defines a mating section which is located at an inner half of the inner thin section which is relative farther from the second end opening than an outer half of the inner thin section in a mating direction.

18. The electrical connector assembly as claimed in claim 17, wherein the terminals are essentially assembled to both the dielectric body and the printed circuit board in a common vertical direction perpendicular to said mating direction.

19. The electrical connector assembly as claimed in claim 17, wherein a step structure is formed in a mating port of the dielectric body around the mating sections of the terminals and between the inner half and the outer half of the thin section.

20. The electrical connector assembly as claimed in claim 19, wherein another step structure is formed in the mating port of the dielectric body between the thick section and the thin section.
